(19) United States
(12) Patent Application Publication
(10) Pub. No.: US 2009/0261207 A1
(43) Pub. Date: Oct. 22, 2009

(54) Stable aircraft

(76) Inventor: George A. Teacherson, Royal Palm Beach, FL (US)

Correspondence Address: George Teacherson, 103 Conaskonk Circle, Royal Palm Beach, FL, 33411, US

(21) Appl. No.: 12/386,454

(22) Filed: Apr. 17, 2009

Related U.S. Application Data
(60) Provisional application No. 61/124,574, filed on Apr. 17, 2008.

(51) Int. Cl. B64C 39/08

(52) U.S. Cl. 244/45 R

(57) ABSTRACT

An aircraft is made stable via shortening the chord of the wings to shorten the travel of the wing's center of pressure. Since short chord wings have less wing area than normal wings, a multitude of short chord wings is necessary to regain the required lifting area for flight. The instant stability does not degrade aircraft maneuverability or high performance.

### PROVISIONAL

This application claims the benefit of the earlier filing date of the provisional patent application Ser. No. 61/124,574, filed Apr. 17, 2008 by the instant inventor.

### FIELD OF THE INVENTION

This invention relates to the art of stability and control for flying machines and more particularly to innate self-stability of an aircraft via control of the center of pressure.

### BACKGROUND OF THE INVENTION

A typical aircraft experiences wandering center of pressure as it goes through its flight envelope. Center of pressure movements around the center of gravity cause the wing and thus the aircraft attached to the wing to experience instability.

In the early 20^{th} Century, Alexander Graham Bell built a full scale aircraft using a series of small triangular kites fitted together to fashion the whole. This proved to be a very stable aircraft in flight. But the configuration was so non-standard it found no favor in the aviation community. Taking its cue from the birds, all aircraft at the time had standard straight wings. Wings are of “normal” chord when the chord and wingspan are both wide enough to sport sufficient wing area to lift the aircraft.

No one at the time, including Bell, understood why Bell's configuration was stable, but no one cared about it either. The small triangular lifting surfaces were just too weird to be taken seriously. However we now know that its stability arose directly from the multiple, short-chord kite segments Bell was using. The segments were decidedly not wings. Nevertheless, taken together as a whole, they produced sufficient lift for a man-carrying aircraft. The stability arose from each triangular piece producing a minimal movement of the center of pressure. The aircraft however was a failed experiment.

Contrarily, designing a winged aircraft to deliberately act stable in flight is now a simple matter of equipping it with a multiplicity of preferably high-aspect ratio but short chord wings. The reason is that over a short chord, the center of pressure cannot shift very much. Thus the aircraft retains stability throughout its flight envelope. The instant multiplicity of wings gives the required-for-flight overall wing area. Wing area for flight has always been the prior art requirement that must be met via wingspan plus chord. Contrarily, in the instant invention, minimizing the travel of the center of pressure comes first. This necessitates the instant short chord wings.

If a flying car is to become a staple of future transportation, it must be something having innate stability and requiring minimal control expertise by the public. The instant invention is perfect to fulfill that role.

If a type of straight, swept, delta or other, or new, shape of wing can be fashioned using a multiplicity of short chord wings, an aircraft can travel through a multiplicity of flight regimes and remain stable at all times. This is a novel concept.

There are aircraft with a plurality of wings. Biplanes. Triplanes. Staggerwing biplanes. Multiplanes of varying designs. These designs use normal wings that add up their wing area to the necessary overall flight area for total needed lift based upon the lifting cross section, its coefficient of lift and its lift-drag ratio. Instability in such early types of planes is legendary. There are designs of aircraft with a plurality of essentially normal but high lift wings by the instant very inventor. The instant inventor has also seen TV pictures of a flying bomb having what looked, on the surface, to be short chord, cantilevered high aspect ratio wings. But in fact it was a cantilevered biplane with its wing area correct for the design, i.e.: normal for the overall size. Furthermore, the wings were guide fins and did not lift. So the configuration is instantly not apt. And there are prior art short chord control surfaces such as ailerons and the like. In fact, in the prior art, short chord surfaces are used exclusively for control. These and the like are well known short-chord aerodynamic devices. However, instantly is the first time that a stable aircraft has been conceived specifically using a plurality of specifically and sufficiently short chord full-scale wings such that the center of pressure is designed not to shift or to shift only minimally during the aircraft's entire flight envelope. Preferably, these short chord wings also have high-efficiency, high aspect ratio. The instant wings have far less wing area than needed for total lift. Their plurality is necessary to add up wing area since area is, unlike the prior art, instantly secondary to control of the center of pressure. Thus, very unlike the prior art, highly maneuverable aircraft from slow speeds to supersonic may be made after the manner of the instant invention and be completely stable while remaining eminently maneuverable throughout all aspects of flight.

Thus, it is an object of the instant invention to provide an aircraft with a multiplicity, a plurality of short chord wings that keep center of pressure movement small.

### BRIEF DESCRIPTION OF THE DRAWING

Many aspects of the present disclosure can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. The several figures of the drawing, in which like designations denote like elements, are representative only and do not appear as limiting in any way.

FIG. 1 is a plan view of a three-wheeled version of the instant invention.

FIG. 2 is a plan view of a four-wheeled version of the instant invention.

FIG. 3 is a side elevation of a wheel of the invention of FIG. 1.

FIG. 4 is a rear view of ducted channel win g.

FIG. 5 is the ducted channel wing of FIG. 4 showing activated wings.

FIG. 6 is a rear view of a ducted channel wing showing a sliding duct.

FIG. 7 is a transport aircraft having a plurality of short chord wings.

FIG. 8 is a rear view of the transport aircraft of FIG. 7.

FIG. 9 is a cutout view of the fuselage of the instant invention, showing a short chord wing attached to the fuselage via a pivot and an actuator within the fuselage.

FIG. 10 is a sectioned view of a short chord channel wing.

FIG. 11 is a side view of a differing short chord channel wing.

FIG. 12 is a section view of another short chord channel wing.

FIG. 13 is a plan view of the instant invention is all-up configuration.

### DESCRIPTION OF THE PREFERRED EMBODIMENT

Generally, Aircraft 10 is fitted with a plurality or multiplicity of wings 12. Each individual wing 12 has a short chord 20 and is preferably a high aspect ratio wing. The high aspect ratio is the most efficient lifting wing shape. Thus, high aspect ratio is preferred.

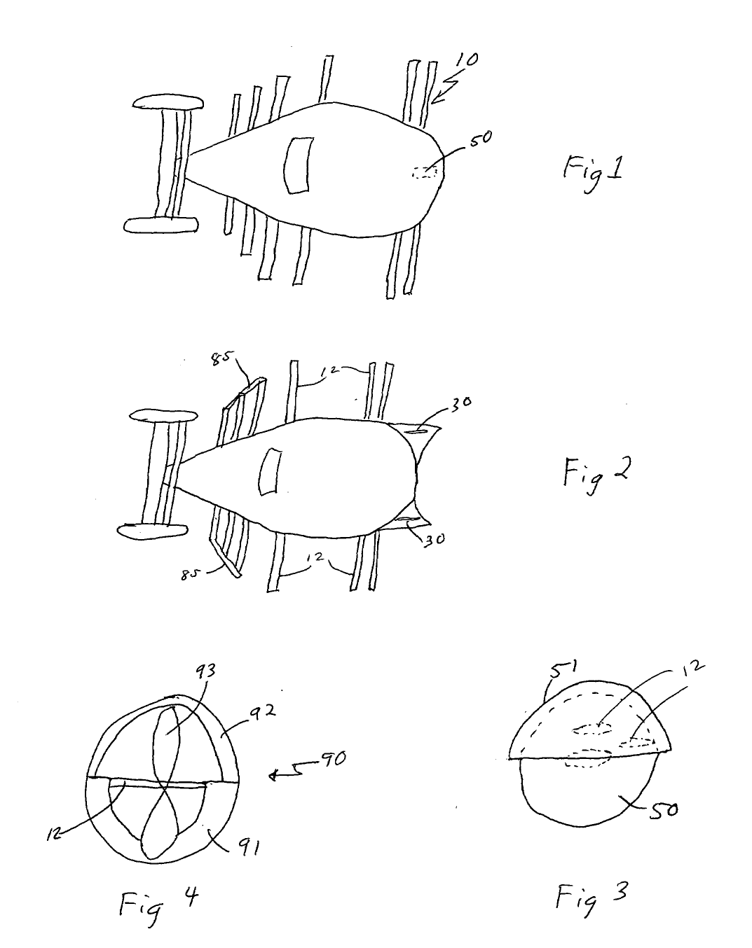

FIG. 1 shows a three-wheeled version of the instant invention 10. This aircraft 10 can be ground licensed as a motorcycle. FIG. 2 shows a four-wheeled version 10 that can be ground licensed as an automobile. FIG. 2 also shows structural ties 85 used to add stability, to wing tips, to the overall structure and to mitigate flutter. One level of wings 12 is shown but it should be understood that multiple levels of wings 12 may also be used as necessary or desired by a designer.

Wings 12 may be telescoping in a known manner or foldable as in Navy wings applications. Such well known means for reducing span for parking, storage, or in the instant case also ground travel need not be shown. The instant drawing is dedicated to the novel aspects of the instant invention 10 only.

Further, fuel tank(s) and rocket pod(s) (not shown) can be removably added to vehicle 10 to allow it to perform ballistic hops into space or even into orbit as vehicle 10 may be designed to do. The pods are preferably made removable so to keep the ground or air vehicle 10 small in its normal day-to-day operations. Hence, turning vehicle 10 into a space vehicle 10 using rocket engine pod(s) need not be a permanent thing and if made removable, the structure of space vehicle 10 need not weigh down the instant air vehicle 10. It can then fly from home to space.

FIG. 3 shows how a plurality of short chord wings 12 can provide structural stability for the wheel 50 well 51 or wheel housing 51. With proper aerodynamic design, a grouping of short-chord wings can be positioned to increase the amount of overall lift than would be produced by adding the lift vectors of each wing 12 individually. Similarly with proper design and aerodynamic placement, leading wings 12 could feed a higher speed airstream to the trailing wings 12 in the grouping that via physics result in higher lift generated by the trailing set of wings 12 of the plurality. Hence it is seen that the plurality of wings 12 need not merely act as structural members and that aerodynamic enhancement of the airstream may also be instantly designed in to the grouping. This capability is not possible in the prior art. Note also that inside one of those short chord wings 12 could be the ground steering mechanism (not shown). Steering can be standard rack and pinion, electric motor driven, standard aircraft rudder pedal movement driven or any other method as desired. The wheels 50 themselves or the entire wheel wells 51 can move. None of these options is novel and need not be shown. This keeps the drawing clear and provides clarity as to what is novel.

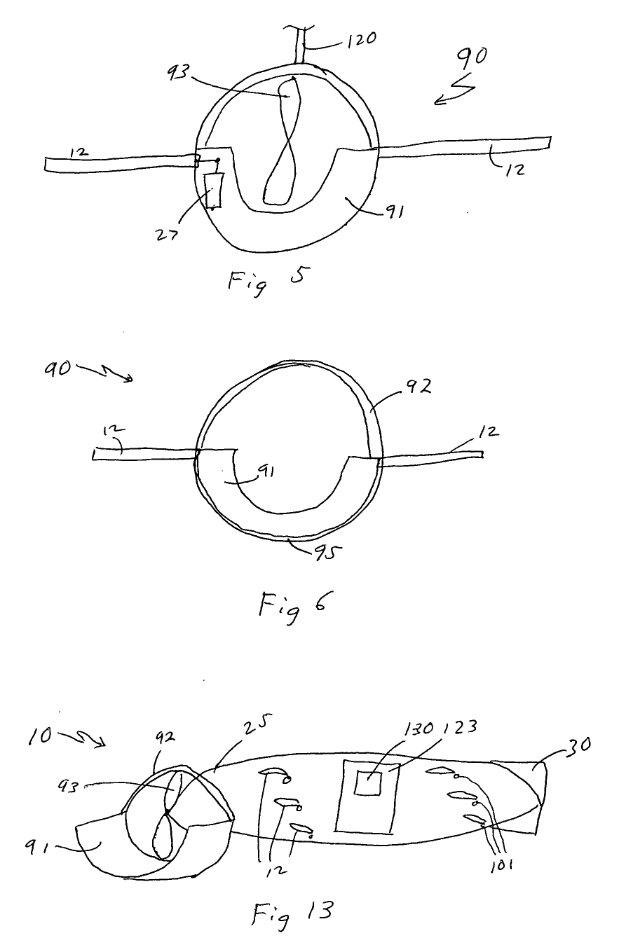

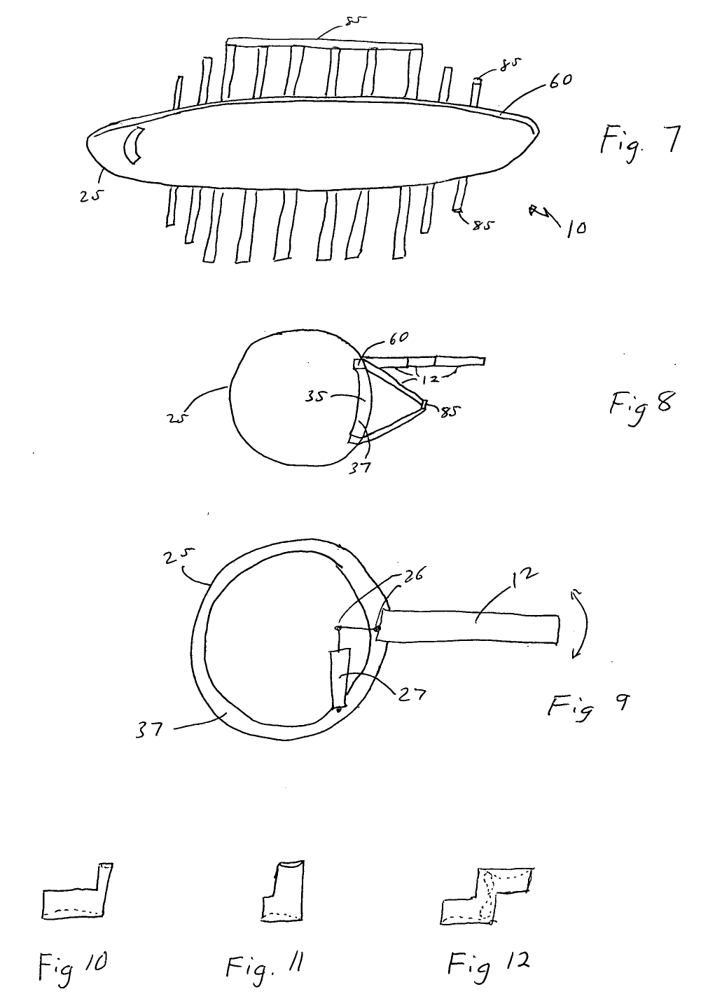

FIG. 7 shows that the instant stable aircraft 10 can also be a transport aircraft 10 having the fuselage 25 of a transport airplane, itself having a plurality of short chord wings 12 attached across a minimum of one hard longeron 60 in the top, bottom or both of that fuselage 25 as well as in the middle. Top attachment is shown. Since each individual one of the short chord wings 12 does not weigh as much as a normal wing and also does not itself alone produce as much lifting force as a normal wing, the at least one enhanced-strength longeron 60 need not be as heavy as a normal wing box and the whole may even be lighter in overall weight than normal standard wing attachments plus wings.

Further, since a prior art cross-fuselage 25 wing box is not needed, it may be possible to attach wings 12 to any of at least one enhanced longeron 60 of fuselage 25 without compromising interior space within fuselage 25.

Note that the attachment of short chord wing 12 to fuselage 25 may use a combination mounting of at-least-one-longeron-and-at least-one-rib for extra structural stability. Whatever may be most suitable for the aircraft 10 is preferable.

FIG. 8 shows the plurality of short chord wings 12 coming out from the transport aircraft 10 fuselage 25. Note that in a jet or high-speed transport 10, the wings 12 would preferably be swept. Furthermore, additional stability for the short chord wings 12 can be had by having at least one hard longeron 60 at the bottom of transport 10 with short chord wings 12 coming out from it as well. Then the top wings 12 and bottom wings 12 are attached together at their tips (ties 85) forming a solid triangle structure. See FIG. 7. Here typical well known fuselage 25 ribs 35 and enhanced longerons 60 would form the third side of the structural triangle. And wingtip structural tie 85 would reinforce the connection. Such a combination would have the additional combination aerodynamic stability advantage of having both dihedral and anhedral as a natural consequence of the triangle structural stability.

FIG. 9 is a cutout view of the fuselage 25 of the instant invention. A short chord wing 12 is attached to the fuselage 25 via pivot pair 26 and an actuator 27 situated within the fuselage 25. Actuator 27 may be a solenoid, or it may be mechanical, pneumatic, or hydraulic as already exists and is well known. It further may be attached by well known means to a well known fuselage rib 37 for structural stability. By moving the short chord wing up or down (curved arrow), the lift generated by said wing can be angled, thus generating a steering moment. Further, wings 12 may be angled as desired, upward for stability enhancement of dihedral; or downward for anhedral. It is further possible to angle or rotate wing 12 forward or backward by equally well-known attachments of actuator to structure. This then would produce a yawing moment for aircraft 10 without the need for rudder 30. A single, known, multi-degree of freedom actuator 27 could perform this action. Multiple actuators 27 may also perform the control activity. And such control activity could occur via the movement of multiple wings 12.

The wing actuators 27 may also perform a novel activity that can only be performed by short-chord wings with no structural ties at their tips. Actuators 27 can be made to wave the wing tips of the instant short-chord wings 12 in flight much as birds adjust their feathers in flight to compensate for gusts and patches of lift. This action can smooth out flight even more than or in addition to the stable center of pressure of the short chord wings 12. Additionally, actuators can make wings 12 travel from straight to swept and back again to maintain efficiency as the vehicle 10 goes from slow to high speed travel, and back again.

In the instant invention 10, ailerons are not needed! Actuating the short chord wings 12 symmetrically will generate roll while a symmetric actuating produces pitch. Yaw may still be made by rudder 30. Rudder 30 is located exemplary at the back of the motorcycle version of FIG. 1 and in dual force on top of the rear wheels 50 and their rear wheel wells 51 in the automobile version of FIG. 2. Note that dihedral plus actuators can form rudders out of wings 12. This configuration would be the known V-Tail in standard airplanes. However, rudders 30 may additionally be installed at the back of and in the high-speed airflow of ducted channel wing 90 of FIG. 4.

Small wings 12 on pylons can also be installed at the back of and in the high-speed airflow of ducted channel wing 90 of FIG. 4. This would be a lift-enhancing structure.

FIG. 4 shows a ducted channel wing 90 from the rear. It is preferably blown as fully described by Englar, et. al. in U.S. Pat. No. 7,104,498. Unlike Englar, however, on the top of the instant normal channel-wing circular wing section 91 is connected a circular or arcuate short chord wing 12, shown as element 92. A full duct 90, comprising in combination channel wing 91 and circular short chord wing 12, or element 92, encircles just and only propeller 93. Prop 93 in the instant configuration only, sees a single environment of the same pressure all around its arc. This is important as it prevents vibration generation that occurred in the original channel wing when its prop traveled from a closed environment within the channel to the ambient environment above the channel. This vibration problem of a channel wing in general was not addressed in Englar, et. al. Yet, this vibration can actually get so bad as to destroy a prop and/or engine! Thus the instant invention solves the vibration problem, does it simply and presents a preferably blown, ducted channel wing 90 using a short chord wing as the protective duct itself 92 and placed over the normal-chord channel wing element 91. The normal chord would be designed for the normal expected flight envelope of vehicle 10. Duct 92 in the instant invention 10 may be an arcuate short chord wing 12 atop the bottom arc 91 of ducted channel wing 90 and blended into the wing 90. Duct 92 could further have an inside, bottom duct cross section the same shape as does duct 90 on its 91 interior sides, but its 92 top, exterior could fashion a differing lifting cross section. Thus there could be two differing wing cross sections across the enclosure. This is entirely novel to the instant disclosure. Though prop 93 is accelerating the air underneath duct wing 12, it can be possible that this would also accelerate air over it as the ambient atmosphere tries to catch up with its accelerated sector. However, simply leaving duct 92 as a neutral, short-chord airfoil cross section or designing it to increase the thrust of prop 93 is perfectly acceptable structure here.

Such banded top structure is seen in FIGS. 6 and 7 of the instant inventor's WIPO publication WO 03/076224 and PCT/US03/06496. The structure is priorly disclosed WITHOUT a single mention of, nor even knowledge of designing wing structure to control center of pressure. The instant disclosure is completely novel. The instant inventor knew of, or thought of nothing like short-chord center of pressure travel prior to the instant disclosure. My publication talks of FIG. 1 having, “duct 31 covers just the depth of the propeller 39” and “It is, in fact, nearly a band 31.” Thus, it is too short to have an aerodynamic chord. However element 37 in FIG. 7 is described thusly: “Note that duct 31 may also be fitted with an outside completely encircling airfoil 37 (FIG. 7) to speed up the airflow exterior of and to the duct band itself.” In other words, airfoil section 37 is used strictly to increase lift by increasing airflow over the top of the duct 31. And further note that airfoil 37 is designed to be added onto the top of duct band 31. Instantly, the short chord wing 12 IS the enclosing band AND ALSO the airfoil section. Teacherson's prior art of course does not disclose this type of structure. The instant enclosing arcuate airfoil is novel as presented. The fact that the enclosing arcuate airfoil is itself a short-chord wing describes even further novelty piled on top of novelty.

The Teacherson prior art ejector nozzle 43 element increases power output. Such an ejector nozzle can also be used herein.

In that publication, Teacherson's propulsor “39” is placed in front of the wing “33” so to assure high-speed airflow over it. Here, in Englar, et al., and in some of Custer's original designs, the propulsor 93 is in the back of the channel wing 91. Therefore note that instant propulsor 93/propeller 93 placement in the instant invention can be either in front of as on or near the leading edge, or it can be on or near the trailing edge of channel wing 91. Rear propulsor 93 placement may depend upon turbulence over the channel wing 91 created by leading edge placement.

As in one of Custer's original designs, a jet engine may be the propulsor 93 with its exhaust exiting over the channel 91. Instantly, however, a turboshaft engine could turn propulsor 93 plus it also may direct its own exhaust over instant channel wing 91 thereby insuring increasing lift plus power. Further its exhaust may be used for blowing and/or other control purposes.

Note also that a ducted channel wing 90 could form the basis for a personal lifting device. Not a rocket backpack as is known, the instant ducted channel wing 90 can operate longer over longer distances and with less or more efficient fuel flow than the prior art rocket belts. As a parawing propulsor would do, the instant ducted channel wing 90 can be mounted upon a user's back in the slipstream of the parawing engine-propulsor combination. Or the channel wing 21 could be mounted in front of the parawing propulsor for turbulence prevention. It could generate 200 to as much as 500 pounds of lift and allow the user to rise personally into the air without need for a parawing glider. The ducted channel wing 90 backpack is far more capable of personal lift than any prior design. In this application, an open channel wing 91 itself is novel by itself. This is such a novel design that even an enclosing band instead of a short chord duct distinguishes from prior art.

Thus, design of a ducted channel wing 90 backpack can begin starting from a parawing glider motor having a wire-enclosed propeller as is typical of the art. The wire enclosing structure can then serve as structural support for the enclosing band or lifting airfoil or short chord wing over its top section 92. This enclosing top section 92 is instantly preferred so to maintain a single propeller environment. Since this design has never existed before, be it known also that a typical unbanded channel wing 91 backpack is completely novel. But the band is preferred for propeller protection. The existing wire support can then be adapted to support a channel wing 91. Once the channel wing 91 is formed and mounted, the backpack 90 can be donned by a user, the engine started and the channel wing 91 would then preferably produce sufficient lift to carry the user aloft.

Although parawings can be worn on a user's back, some parawing gliders come with a wheeled, seated structure to make flying easier for the user. Such known structure may also be used in the instant channelwing 91 lifting personal glider 10.

Note that such a wheeled, seated structure in a lifting personal glider 10 can also sport normal chord wings and have a configuration of short-chord wings 12 as well.

The winged structure can have the ducted channel wing 90 on back or not as may be desired for proof of concept purposes—or other purposes. Engines may be piston, jet, rocket or other as may be needed. The tiny wheeled parawing structure can be a useful testbed for a multitude of needs.

Furthermore, depending upon the power of the engine used, blowing the ducted channel wing 90 is also a distinct possibility for the instant lifting personal glider 10.

Note also that a ducted channel wing 90 could form the basis for a heavy lifter. A preferred plurality of engine-channelwing 90 combinations could have their weight supported on a rig that is lifted by a balloon or dirigible. The lift produced by the ducted channelwings 90 would be directed to lift exterior heavy loads. For steering, each wing 90 could be rotatable through as much as 360 degrees. Or see next paragraph for other methods.

According to Strumbos, U.S. Pat. No. 4,804,155 for a “VTOL Aircraft”, a fully ring wing can be steered via spoilers placed interiorly of the rings. They steer by spoiling the fast flow, slowing it down and thereby increasing the pressure at various points inside the complete ring. This too, can be a means for steering for the instant invention 10. Spoilers may not need a hugely powerful engine and thus may be ideal steering particularly for the instant personal lifter 10.

It is interesting and apt to note that the prior art makes a completely separate design for ring wings and channel wings. Channel wings are ALWAYS open wing channels into which a prop is stuck. At no time has the prior art tried to protect the top of the propeller arc with a short chord wing. This fact is true even for this instant very inventor's past designs. Teacherson's own Elements 31 and 37 were a high lift design combination that protected the prop 93 along its arc. At no time has short chord wing center of pressure control ever come up. It is a novel concept with the instant invention only. The instant inventor's thought processes knew nothing of short-chord flight control until this very application. And Teacherson's prior art never thought to make the airfoil 37 and belt 31 a single element.

Englar, et al, also has a non-mechanical, non-moving-part means of flight control via differential blowing of the channel wing flight surfaces. This blowing serves two purposes. First, it increases the lift and stability control. Second, it allows for flight control. The instant invention 10 may well use Englar's design along with the instant short chord wing ducting. Short chord wing ducting does not appear anywhere in the prior art. It is novel to the instant disclosure. Thus Englar's design would do very well to license the instant invention to protect its own propulsor 93. The heavy lifter could use differential blowing for its steering as well.

The instant ducted channel wing 90 may also have a circular short chord wing section 12 as its bottom wing in place of a normal wing section. See FIG. 10. But in order to make it a non-ring wing, the bottom chord necessarily and by definition must have greater chord than the instant top, instantly enclosing circular short chord wing section 12. Thus, it has a very short top chord encircling wing coupled with a longer but still short-chord bottom channel wing. As for having a ring wing with yet another way to make it a non-prior-art ring wing is to have the very top of the standard normal ring duct 92 fitted with a short-chord wing 12. FIG. 11. It becomes a short-chord ring wing. Neither configuration appears in the prior art. Nor does a third method whereby either a short-chord or normal chord channel wing places the propulsor 93 at its trailing edge while the short—or even normal—chord enclosing ring is offset and places the same propulsor 93 at its leading edge. Or vice versa. See FIG. 12. Hence, the propulsor 93 sees only a fully enclosed environment all the way around. The short chord wings 12 aerodynamic and control benefits are maintained. And the instant invention 10 remains entirely novel. No such designs are even hinted at in any known prior art.

Use of ducted channel wing 90 enhances overall lift generated by aircraft 10 and reduces the number of short chord wings 12 needed to provide the necessary total lift. This makes aircraft 10 smaller in overall dimensions. That is why a short-chord-ducted, blown channel wing 90 is made a part of this disclosure. It is a preferable embodiment.

Any individual one wing 12 in particular or all or a grouping as desired of short chord wings 12 can be fitted with high lift cross section.

An additional high lift device is a Magnus rotor. A small Magnus rotor 101 placed at the trailing edge, preferably, of short chord wings 12 sets up an airflow circulation (according to Navy studies of such rotors) that increases lift not only some 10 times higher than the normal lift produced by an airfoil but it also gives 30 times more lift than if such a rotor is placed at the wing leading edge.

Thus FIG. 13 shows a preferred flying car 10 with the aerodynamic devices in place. Fuselage 25 with door 123 and window 130 has ducted and preferably blown channel wing 90 on its nose plus short chord wings 12 with Magnus lifting rotors 101 at their preferred trailing edges. For flying car purposes, as well as other vehicles, it is preferable to enclose prop 93 within a fully circular enclosure, here made up of channel wing 91 and arcuate wing 92 for safety reasons. It helps keep the whirling prop from endangering life and limb in a street or neighborhood, for instance. Its other aerodynamic benefits are described above.

FIG. 5 shows ducted channel wing 90 with two short chord outrigger wings 12 attached at the top of normal channel wing 91. Actuator 27 is shown within wing 91. This is conceivably a situation where control moments may be generated for the entire aircraft using only ducted channel wing 90 without blowing control. Wing 90 can be directly connected to the engine pod (not shown) with prop 93 directly connected to the engine (not shown) drive shaft (not shown). Engine, engine pod and driveshaft are well known to the art and do not comprise innovation in the instant application. They can also be seen in Englar, et al. For specific engine designs please see U.S. Pat. No. 6,779,334 issued to the instant inventor. Other prior art engines can be used in the instant invention as well. Also, rotating the entire combination of engine and wing 90 horizontally through up to 360 degrees of rotation via a vertical shaft 120 is a novel instant take on water ship propulsors called azipods. Add to the instant rotation, additional actuators 27 that move the vertical shafts 120 of wings 90 upward to direct propulsor thrust downward and dual thrust lift can be generated both from channel wing 90 lift and direct thrust power lift.

See FIG. 6. Wing Duct 92 may be fitted into groove 95 set into the trailing edge of channel wing 91. Wing 12 can be mounted upon full duct 92. An electric motor (not shown) and/or hydraulics as for instance may be properly connected as is well known in the art. The Pegasus VTOL engine of the Harrier aircraft has variable thrust ducting and is one good example of such a mounting. That mounting actually makes use of motorcycle chain to effect duct rotation. The instant configuration is set to allow duct 92 to slide in groove 95. In sliding, it rotates and duct 92 will take wing 12 with it. Thus, no dedicated actuator 27 is needed in order to effect roll. Pitch can still be effected via the configuration of FIG. 9. And since normal chord channel wing 91 has the room for at least one additional short chord wing 12, the configuration of FIG. 9 can also be emplaced into the configuration of FIG. 6 in the channel wing 91.

Note however that dual ducted channel wings 90 can roll asymmetrically to produce pitch. Dual ducted channel wings 90 can roll symmetrically to produce roll. Dual ducted channel wings 90 can be useful by themselves to produce more thrust from engine power for aircraft 10 or each can be attached to its own engine (not shown). The number of ducted channel wings 90 can be set according to design for each individual aircraft 10. Rotating wings 90 to effect directional control is still another method.

Attaching straight wings 12 both at the apex of the short chord duct 92 and in their normal channel wing side emplacement area is also fully practical in the instant case. Clearly such a wing 12 configuration cannot appear in the prior art.

Thus overall, ducted channel wing 90 can be configured with short chord wings 12 to effect lift, pitch, roll, and yaw. Wing 90 has normal chord channel wing 91 for typical wing area and additional short chord wing(s) 12 can be added as desired. Wings 12 may be attached between wings 90. With at least dual ducted channel wings 90, short chord wings 12 can be attached between same to enhance structural stability of wings 90 or merely to use the space between same for additional lift area. And as said earlier, a grouping of wings 12 may be designed to produce enhanced lift aerodynamically.

In a transport, cargo aircraft or flying bus, FIG. 7, at least one enhanced-strength longeron 60 can form the structural backbone for a series of short chord wings 12. Wings 12 can be just as long as normal wings of transport aircraft and tied together at their ends or via wingtip ties 85 for structural stability. They could also be far shorter. Also, additional structural ties 85 can be placed anywhere along the span of wings 12.

See FIG. 8. Instead of one normal wing with one heavy wing box with a center of pressure that has to be controlled manually or lately via expensive computer along with backup computers, the series of short chord wings 12 prevent large center of pressure movements without expensive electronics and without the innate stalling danger of the normal wing that must be manually controlled with aviator expertise.

Structural ties 85 can be utilized to prevent flutter or other types of aerodynamic vibration caused by the plurality of short chord wings 12. As can blowing or even other types of structural enhancements.

Well-known winglets (not shown) can be placed onto structural ties 85.

Structural ties 85 can be shaped into an elliptical planform, a delta or any new or other shape allowing the vehicle 10 to be aerodynamically designed for maximum performance and stability in whatever flight regime. All wings 12 need only be designed as straight and simple-to-produce, cost-effective lifting wings but with short chord. That is whether or not they are swept in relation to the airstream. They are produced as simple, straight wings. Thus whatever planform the overall wing platform takes, the instant invention 10 is simpler and cheaper to produce than prior art normal chord wing shapes. It may also be lighter in weight than prior art methods of wing manufacture.

Via use of an actuator 27, the entire wing 12 setup can be swept from straight to full sweep and any form in between while made to slide within ties 85. Ties 85 still prevent flutter and also provide a mounting for the necessary wing 12 tips pivots required to effect the sliding movement.

Thus the instant invention can be used as a stable platform for aircraft in all manner of wing shapes and flight regimes, including supersonic and military applications as well as all civil applications. Overall wing design is freed for new shapes of all kinds. For instance, structural ties 85 may take the shape of a reverse delta where the leading short chord wing 12 is swept forward while the trailing short chord wing 12 is swept backward for high speed flight. In between them the remaining short chord wings sweep forward to straight to backward and they all have their roots closer together than they have their tips. The straight position may in fact be skipped. A reverse delta never appears in the prior art and cannot be made stable by the prior art. But instantly, it is both stable and highly maneuverable in low-speed all the way to high-speed environments. Stable and maneuverable is not possible in the prior art. Furthermore, a structural triangle can be made using the forward swept wing 12 plus tying it to a typically swept back leading short chord wing 12. Here, structural triangles can be formed all across the fuselage 25 and on multiple levels and up-down for further triangular stability. Instant invention 10 shows an unlimited novel design set. The instant invention 10 distinguishes and shows the way in both structure and maneuverability while fully maintaining stability throughout the flight envelope.

IN OPERATION, as aircraft 10 flies, short chord wings 12 limit the travel of the center of pressure due to their short chord. In so limiting, wings 12 remain stable throughout the flight regime of aircraft 10. Short-chord-ducted, blown channel wings 90 can be provided preferably with a circular short chord wing 92 placed atop the channel 91 forming the duct 90. Wing 90 is provided for increased lift and even directed control. It can also form a personal backpack or a heavy lifter. Short chord wing 92 ringing the top half performs the novel dual function of providing lift without pressure excursions plus keeping the propulsor 93 within a closed-walled environment throughout its full arc. At least one straight wing 12 of whatever chord can be attached to channel wing 90 in more than one position to provide further lift and be used as a flight control surface. Magnus rotors may be placed at the leading or trailing edges of wings 12.

Short chord wings 12 can be used to help lift vehicle 10 while it has rocket pods preferably removably attached for turning it into space vehicle 10. Wings 12 would help make the entire space vehicle 10 smaller, lighter and cost effective to become the basis for the next generation of space vehicles.

It should be emphasized that the above-described embodiments of the present invention, particularly, any “preferred” embodiments, are merely possible examples of implementations merely set forth for a clear understanding of the principles of the invention. The overall Spirit of the instant invention in not only its disclosed form but also in all other conceivable embodiments thereof, is what I seek to protect. Many variations and modifications may be made to the above-described embodiment(s) of the invention without departing substantially from the spirit, scope and principles of the invention. All such modifications and variations are intended to be included herein within the scope of this disclosure and the instant invention and protected by the following claims.

Further, the purpose of the following Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

I claim:

1. A stable aircraft comprising:
A fuselage, and
A plurality of short chord wings.

2. The aircraft of claim 1 wherein said short chord wings have high aspect ratio.

3. The aircraft of claim 1 wherein said fuselage also has at least one ducted channel wing.

4. The aircraft of claim 3 wherein said ducted channel wing has at least one of a short chord winged duct and a normal channel, a short chord duct and a short chord channel, said channel and said duct each approach a propulsor at opposite ends, i.e. leading edges and trailing edges, said short chord duct having two different wing planforms, at least one short chord straight wing attached thereto, wing position actuators situated therein, said wing position actuators can be made to wave said straight wings, said duct can roll, said duct has direct thrust power lift capability, said duct is rotatable horizontally through 360 degrees, and said duct is blown.

5. The aircraft of claim 1 wherein said short chord wings have at least one of high lift capability, mounting on at least one enhanced-strength longeron, triangular mounting of a plurality of short chord wings plus use of ribs and longerons as structural triangles, wingtip ties and Magnus rotors.

6. The aircraft of claim 1 wherein said aircraft is adapted to at least one of receive removable rocket pods, form a lifting personal device, form a heavy lifter, form a ground vehicle, form an air vehicle, fly from home to space and be highly maneuverable in low-speed all the way to high-speed environments.

7. A stable aircraft, comprising:
A suitable fuselage;
Said fuselage having a plurality of short chord wings; and
Said short chord wings having minimal center of pressure movement throughout the flight envelope of said aircraft.

8. The stable aircraft of claim 7 wherein said short chord wings have at least one of high aspect ratio, high lift, attach points to an enhanced strength longeron, attachment to a channel wing, anhedral, dihedral, grouping that increases lift, structural ties, structural triangles, sweep, actuators, waving capability, telescoping capability, folding capability, new planform shape designs and Magnus rotors.

9. The stable aircraft of claim 7 wherein said fuselage has at least one of channel wing, ducted channel wing, blown, ducted channel wing, rotatable channel wing, directed channel wing, door and window.

10. The stable aircraft of claim 9 wherein said channel wings have at least one of horizontal rotating capability, and steering capability.

11. The stable aircraft of claim 7 wherein said aircraft can be adapted to additionally act as at least one of a motorcycle, an automobile, a bus, a ground vehicle, a heavy lifter, a personal lifter, an air vehicle, a home to space vehicle and act highly maneuverable in low-speed all the way to high-speed environments.

12. Method of making a stable aircraft, comprising:
Providing a fuselage;
Providing at least one short chord wing on said fuselage; and
Providing said at least one short chord wing to remain stable via minimal movement of center of pressure throughout said stable aircraft's flight envelope.

13. The Method of making a stable aircraft of claim 12 wherein said at least one short chord wing can provide at least one of numerous planforms and highly maneuverable in low-speed all the way to high-speed environments.

14. The Method of making a stable aircraft of claim 12 wherein said fuselage is provided with at least one channel wing.

15. The Method of making a stable aircraft of claim 14 wherein said at least one channel wing is provided with at least one of short chord airfoil to duct a propulsor thereby forming a ducted channel wing and said channel wing is further provided with optional blowing and optional rotating and optional directing.

16. The Method of making a stable aircraft of claim 12 wherein said aircraft can be provided with at least one of personal lifting capability, motorcycle capability, automobile capability, bus capability, rocket capability, ground travel capability, air capability and capability of traveling from home to space.

17. The Method of making a stable aircraft of claim 16 wherein said capability can be provided with stable flight from low speed to high speed.

18. The Method of making a stable aircraft of claim 12 wherein said at least one short chord wing is provided with at least one of Magnus rotor, optional folding capability and optional telescoping capability.

19. The Method of making a stable aircraft of claim 12 wherein said at least one short chord wing is provided with at least one of waving capability and wingtip waving capability.

20. The Method of making a stable aircraft of claim 12 wherein said aircraft is further provided with at least one of channel wing, means to move said channel wing, means to rotate said channel wing, means to mount additional ones of said short chord wings upon said at least one channel wing, means to steer.
